(19) United States
(12) Patent Application Publication
(10) Pub. No.: US 2017/0127103 A1
(43) Pub. Date: May 4, 2017

(54) METHOD FOR MANAGING THE SELECTION OF THE REPRESENTATION OF SEGMENTS OF MULTIMEDIA CONTENT TRANSMITTED OVER A COMMUNICATION NETWORK

(71) Applicant: Orange, Paris (FR)

(72) Inventors: Bertrand Berthelot, Bourgbarre (FR); Patrice Houze, Rennes (FR)

(21) Appl. No.: 15/301,710

(22) PCT Filed: Apr. 21, 2015
(86) PCT No.: PCT/FR2015/051081

§ 371 Date: Oct. 3, 2016

(30) Foreign Application Priority Data
Apr. 23, 2014 (FR) 1453655

(51) Int. Cl. H04N 21/254; H04N 21/6332; H04N 21/234; H04N 21/643; H04L 29/08; H04L 29/06; H04N 21/2343; H04N 21/845

(52) U.S. Cl. CPC H04N 21/2541; H04N 21/23439; H04N 21/6332; H04N 21/8456; H04N 21/643; H04L 67/02; H04L 65/60; H04N 21/234

(57) ABSTRACT

The invention relates to a method for managing the representation of data segments of content received by a terminal from a server, the method comprising a step of obtaining a document from which universal addresses are generated, one address being associated with a representation of the segment in question selected by the terminal among a plurality of representations described in the document, the segment being capable of being received from the server and decoded by the terminal, characterised in that it includes the following steps at the terminal: a step of transmitting a request to access at least one segment according to a first selected representation, and a step of receiving said at least one segment according to a second representation, as well as information relating to the second representation suitable for being taken into consideration for decoding the received segment.

### TECHNICAL FIELD

The invention relates to a method for selecting the representation of segments of a multimedia content transmitted over a communication network.

Multimedia content means any audio or video content, or more generally any other digital content.

The invention concerns more specifically the transmission and reception of multimedia contents over a network, in particular the continuous downloading, also called streaming, of multimedia contents over a network.

It relates more precisely to a communication using universal content addresses.

It applies notably to any client terminal (hereafter simply called a terminal) capable of communicating over a telecommunications network for accessing a multimedia content via a universal address, also termed a URI (Uniform Resource Identifier).

Representation of a content here is understood to mean a particular way of creating a data stream representative of a content. A data stream created with an encoding throughput is an example of a particular representation of the content.

### PRIOR ART

For accessing a multimedia content, a client terminal generally has recourse to a universal address (URI). Such an address provides both access to the content and information on the associated protocol for consuming it (consuming, means, for example, in the case of a video content, downloading/receiving the content for optionally decoding it later, then viewing it).

A URI address is a string of characters identifying a physical or abstract resource. The syntax of a URI address respects a set of standards promulgated by the IETF (Internet Engineering Task Force), and notably the specification RFC 3986 (specification: Uniform Resource Identifier (URI): Generic Syntax). Such a universal address will take, for example, the form dvb://content1, rtsp://content2, HTTP://content3, ftp://content4, etc.

Access to the multimedia content is triggered by a request, through a URI address. A classic illustration is a video-on-demand service:
a first step is for the terminal to download a document describing the parameters for accessing the service (SDP for Session Description Protocol) via an HTTP protocol (Hyper Text Transport Protocol), a client-server communication protocol developed for the Internet networks and in particular the Web;
in a second step, the service actually starts up, i.e. the client terminal can receive and display the video, thanks to the information provided in the document (in this example, the SDP). It should be noted that this document may be a computer file or a set of descriptive information of the content accessible at a certain address.

Hereafter, according to context, the expression “description file” or “document” will be used. It should be noted that this type of access to the service may require the presence of a server (notably in the case of a point-to-point or “unicast” communication) or may not require it (in the case of a “broadcast” or “multicast” type of point-to-multipoint communication). Notably, the HTTP protocol is of the point-to-point (“unicast”) type, and accordingly involves the presence of a server in order to process the request of a client termed an HTTP client.

It is common, in this context of the HTTP protocol, for exchanging the data between the client and the server, to have recourse to an “HTTP adaptive streaming” technique. This type of technique notably offers a good user experience while taking into account, for example, variations in bandwidth on the connection between the client terminal and the content server. Conventionally, different qualities may be encoded for the same video, corresponding, for example, to different throughputs. Each throughput is itself split into temporal segments (or content “fragments”). The description of these different throughputs and the segmentation, as well as the content fragments, are made available to the client terminal on a service platform. To be able to access the complete content, it is therefore necessary to know numerous addresses (URI) corresponding to multiple segments (referred to as media segments by the person skilled in the art).

There are several solutions for facilitating the distribution of such a content in streaming mode. These methods provide for sending the client one or more intermediate description files, also referred to as documents, or manifests, or resources, containing the addresses of the different segments with the different qualities of the multimedia content. The basic principle of these methods is to make available contents with different throughput variants, each of the variants being available in the form of contiguous segments of media data which are downloadable by the clients using the HTTP protocol.

Reading a content according to the “HTTP adaptive streaming” technique for a given client terminal consists in:
downloading and analyzing the description document which gives the description of the content, the available throughput variants, and the means of accessing the data segments for each throughput variant;
downloading the data segments, and for each segment selecting a particular representation, in particular selecting a throughput for encoding the segment to be downloaded;
then analyzing and assembling the data segments in order to decode them for reading the content.

There are two modes of selecting (or adapting) the representation of the segments. According to a first mode, the client terminal is responsible for the selection; according to a second mode, the server is responsible for the selection.

According to the first mode, it is up to the client terminal to select the representation for each segment of media data according to parameters internal to the client (e.g. measured bandwidth, terminal capacities, etc.); in particular, the client terminal selects a given encoding throughput for each segment. If the bandwidth measured by the client is sufficient, the client will most often select a high encoding throughput. However, the fact of leaving the adaptation decision solely to the client terminal prevents the content distributor from having control of its platform (servers), its network, and services. The major risk for the distributor is having to serve too high a number of requests for access to the segments with a high encoding throughput. The consequence would be a saturation of the network bandwidth or HTTP servers. It may also result in a decline in the quality of rendering on the client terminal.

In the second mode, the representation is chosen by the server or any component of a broadcasting platform (e.g. proxy CDN). In this configuration, the content sent to the client may correspond to a segment with a throughput different from that requested by the client, for adapting to network conditions, for example. The inventors have found that this mechanism poses a problem at the terminal since the decoding parameters are potentially different from one representation (throughput) to another, and the terminal then has no means of knowing that the received segment corresponds to a different representation from that requested. This results in errors in the decoding of the received segments.

The invention offers a solution not exhibiting the drawbacks of the prior art.

The Invention

For this purpose, according to one functional aspect, the subject matter of the invention is a method for managing the representation of the data segments of a content received by a terminal from a server, the method comprising a step of obtaining a document from which universal addresses are generated, one address being associated with a representation of the segment concerned selected by the terminal from multiple representations described in the document, the segment being capable of being received from the server and decoded by the terminal, characterized in that it includes the following steps at the terminal:
a step of transmitting a request for access to at least one segment according to a first selected representation,
a step of receiving said at least one segment according to a second representation, and a piece of information relating to the second representation capable of being taken into account for decoding the received segment.

Thanks to this solution, the representation of the segments transmitted by the server is always a representation wanted by the server; the server therefore has control of selecting representations; in addition, the terminal is notified of the change of representation made by the server via a piece of information indicating this change. The terminal may then take into account the information and adapt its operation notably by correctly setting the parameters related to the decoding of the received segments; this without leading to errors in decoding and therefore in rendering the segment related to the fact that the representation of the received segments is not compatible with the current parameterization used for decoding the media segments.

This solution also avoids an update of the description file.

The segment received according to the second representation is transmitted in a message including an http header and a useful part including the segment. According to a first embodiment, the information is included in the http header.

A segment includes a first part including fields and a second part including at least one coded segment. According to a second embodiment, the information is included in a field (B-evt) of said first part.

The embodiments described above have the advantage of making it possible to read the information before the start of decoding of said at least one segment.

According to a material aspect, the invention relates to a terminal capable of receiving segments of a content, the terminal having access to a document from which universal addresses are generated, one address being associated with a representation of a segment concerned selected by the terminal from multiple representations described in the document, characterized in that it includes
a module for transmitting a request for access to at least one segment according to a first selected representation,
a module for receiving said at least one segment according to a second representation, and a piece of information relating to the second representation,
a processing module capable of taking into account the information for decoding the received segment.

It is understood here that the processing module takes into account the information indicating the representation selected by the server so as to decode said at least one received segment without generating decoding errors.

According to another functional aspect, the invention relates to a method of transmission, by a server, of segments of a content according to a given respective representation, characterized in that it includes the following steps:
a step of receiving a request for access to at least one segment according to a first selected representation,
a step of transmitting said at least one segment according to a second representation, and a piece of information relating to the second representation.

According to another material aspect, the invention relates to a server capable of transmitting segments of a content over a network, characterized in that it includes
a module for receiving a request for access to at least one segment according to a first selected representation,
a module for transmitting said at least one segment according to a second representation, and a piece of information relating to the second representation.

According to another material aspect, the invention relates to a computer program comprising code instructions which, when the program is executed by a processor, performs the steps of the method defined above being executed on the terminal.

According to another material aspect, the invention relates to a computer program comprising code instructions which, when the program is executed by a processor, performs the steps of the method defined above being executed on the server.

The invention will be better understood on reading the description that follows, given by way of example and referring to the attached drawings.

### THE FIGURES

FIG. 1 represents a streaming architecture based on the use of the HTTP protocol on the Internet according to an embodiment of the invention.

FIGS. 2 and 3 represent the circuits of the equipment involved in the method of the invention.

FIG. 4 represents a timing diagram according to an embodiment of the invention.

FIG. 5 represents an exemplary embodiment of the composition of a data stream transmitted by the server to the terminal following a request from the terminal to receive segments.

### DETAILED DESCRIPTION OF AN EXEMPLARY EMBODIMENT ILLUSTRATING THE INVENTION

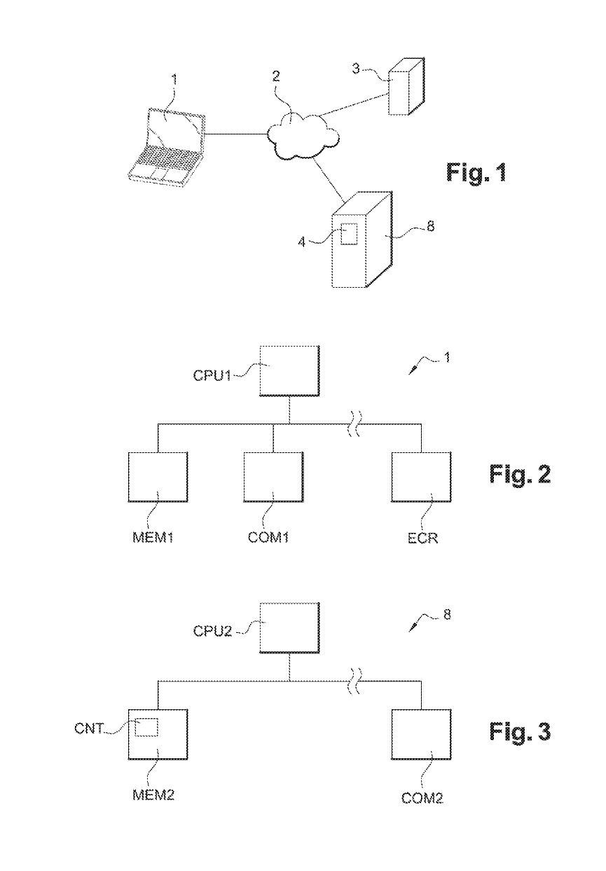

FIG. 1 represents a computer system SYS including a client terminal 1, a service platform 3, and a content server 8, capable of providing a content on request from the client terminal 1. In this exemplary embodiment, the terminal, the platform and the server communicate via an Internet network 2.

With reference to FIG. 2, the terminal 1 includes physical and/or software resources, in particular:
a processor CPU1,
a first storage module MEM1,
a rendering module such as a screen ECR,
a first communication module COM1 for communicating with the network 2.

The modules described above as well as the first microprocessor CPU1 are connected with one another via a first bus BUS1.

With reference to FIG. 3, the server 8 includes
a second processor CPU2,
a second storage module MEM2, notably storing one or more contents CNT,
a second communication module COM2 for communicating with the network 2.

The second module, included in the server, is connected to the second processor CPU2 via a second bus BUS2.

It should be noted that the function of the buses described above is to ensure the transfer of digital data between the various circuits connected to the microprocessor by a bus. In our example, the bus in question includes a data bus and a control bus.

It should also be noted that, in our example, the memories described above are non-volatile read-write memories, e.g. of the flash type.

The terminals also include a random access memory (not represented) for non-durable storage of calculation data used in implementing a method according to embodiments. These memories are not represented in the drawings since they are unnecessary for the disclosure of the invention.

In our example, the architecture selected for illustrating the invention is a “streaming” architecture based on the use of the HTTP protocol. Conventionally, the client terminal (1) wishes to enter into communication with a content server (8) for downloading a multimedia content consisting of one or more media (audio, video, etc.).

It should be noted that the expression “client terminal” implies the presence in the terminal of a client module. In our example, this client module is a computer program.

The rest of the example, as disclosed above, is set in a context of streaming according to the MPEG DASH standard.

The terminal (1) first of all interrogates a service platform (3) for obtaining the address (here, the URL, but in a more general way, a URI type of universal address) of the description document 4 of the multimedia content (y); in what follows, this document is an MPD file (y.mpd).

The general operation of an MPEG DASH session consists, for each representation, in first downloading an initialization segment that contains the decoding parameters; these parameters may differ according to the representation. For this purpose, the description file (MPD) is notably used to generate addresses of the initialization and media segments for each representation of a medium; when a terminal wants to download and decode a media segment of a representation of throughput Vi, it must first obtain the initialization segment corresponding to the representation of throughput Vi. This initialization segment notably contains the decoding parameters that must be used for decoding the content of the media segments of the representation of throughput Vi.

It should be noted that if during a session, the client switches to a throughput Vj then switches again to throughput Vi, the client may reuse the initialization segment previously downloaded and stored in memory.

Thus, at each change in throughput at the initiative of the client, the client retrieves the initialization segment corresponding to the representation of the target throughput and initializes the decoder before decoding the downloaded media segments of this same representation.

Thus, as will be seen later, in the case where the change in throughput is at the initiative of the server, this transmits to the client the identification of the representation to which the segment sent to the client belongs, in order that the client may be notified of the change in representation and thus be able to obtain the initialization segment corresponding to the received segment. At this stage it will be seen that the client is therefore aware of the representation selected by the server and may accordingly adapt its operation (selection of the initialization segment and therefore the decoding parameters) for decoding the received media segments.

Following the interrogation from the terminal, the service platform (3) responds by providing the terminal with the address of the file 4; in the example it is the URL “HTTP://x.com/y.mpd” symbolizing a file y of type “mpd” which can be downloaded on the content server (8) “x.com”.

An example of a description file 4 compliant with the MPEG DASH standard is shown in annex 1. The relevant fields in the context of the invention, which are used notably to generate the universal addresses, are shown in italics.

The description file 4 is used to generate media segment addresses.

This construction implements a preliminary mechanism for resolving universal addresses (URI) described in RFC 3986 mentioned above. The client terminal must interpret certain fields and modify them appropriately for constructing the first universal address (URL or URI) of the media segment.

This URI address resolution is performed according to the BaseURL element, which may be present at different levels of the hierarchy of the file 4.

In this example, the URL addresses are constructed using the two fields “BaseUrl” (“HTTP://x.com/” and “video/”) and “SegmentTemplate”.

The “SegmentTemplate” specified by the MPEG/DASH standard is a generic method of constructing intermediate addresses (URI) from different identifiers, in our example:
$Time$: to be replaced by the start time of the media segment. This time is provided by the “SegmentTimeline” which here indicates an offset of 180180 for each new segment start;
$Number$: to be replaced by the order number of the desired media segment;
$Bandwidth$: to be replaced by the value of the “bandwidth” attribute of the targeted representation.

Thus, the first two URL addresses for accessing the first two video segments for a quality (or throughput) of 500 kbps (kilobits per second) are here:
1. HTTP://x.com/video/500000/0.mp4v, and
2. HTTP://x.com/video/500000/180180.mp4v

It should be noted that multiple possible representations may correspond to the same segment. Here, a respective throughput corresponds to each representation. For example,
HTTP://x.com/video/500000/0.mp4v
HTTP://x.com/video/2000000/0.mp4v

are two possible representations of the first segment, one corresponding to a throughput of 500 kbps, the other to 2000 kbps.

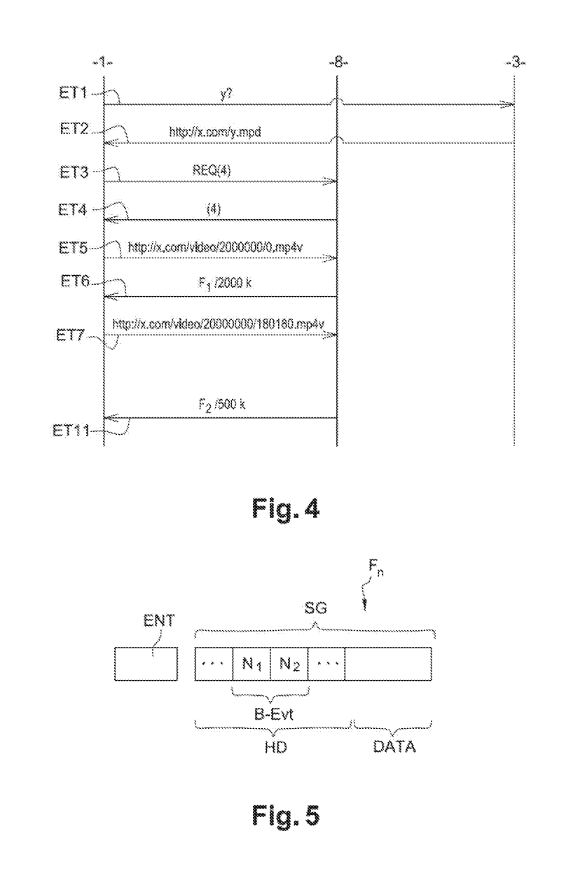

FIG. 4 is a schematic view of the exchanges taking place between the terminal, the platform and the content server.

It is assumed that the terminal 1 wishes to receive a content (y).

In a first step ET1, the terminal 1 interrogates the service platform 3 for obtaining the address (here, the URL, but in a more general way, a URI type of universal address) of the description document 4 of the multimedia content (y); in what follows, this document is an MPD file (y.mpd).

In a second step ET2, the service platform (3) responds by providing the terminal with the address of the file 4, in the example it is the URL

“HTTP://x.com/y.mpd”

symbolizing a content “y” of type “mpd” which can be downloaded on the content server (8) “x.com”.

In a third step ET3, the terminal requests REQ(4) a download of the description file 4 from the server 8.

In a fourth step ET4, the terminal receives and stores the description file 4.

In a fifth step ET5, the terminal (1) accesses the first segment thanks to the first URL1 described above:

HTTP://x.com/video/2000000/0.mp4v.

In a sixth step ET6, the server 8 transmits a first data stream F1/2000k, including the first segments. On reception, the terminal can decode the received segments and render them.

In a seventh step ET7, the terminal (1) requests an access to the second segment thanks to the second URL2 described above:

HTTP://x.com/video/2000000/180180.mp4v.

On receiving the request for downloading the second segment, in an eighth step ET8, the server 8 transmits to the terminal 1 the second segment F2/500k, including the second segment with a lower throughput than that requested by the terminal (1). In other words, the representation provided by the server does not correspond to that requested by the terminal. The throughput selected by the server corresponds to the throughput v1 (500k) if reference is made to the description file in annex 1.

According to the invention, in addition to a transmitted segment, the server also provides the terminal with information relating to the representation of the transmitted segment. The purpose of this information is being read before the decoding of the received segment so that the decoding parameters match the received segment.

It should be recalled that, in the MPEG DASH standard, the server transmits segments in the form of an http response, by means of an http header and a useful part (called a payload in the standard).

In our embodiment, the information relating to the representation selected by the server may be provided in different ways. Two variants will illustrate two possible cases.

According to a first variant, for example, the information on the representation may be inserted in the http header of the response from the server to the terminal.

The header is, for example, the following:

HTTP/1.1 200 OK

Date: Tue, 15 Apr. 2014 09:16:16 GMT

Server: Apache/2.2.25 (Win32)

Last-Modified: Tue, 24 Dec. 2013 15:02:48 GMT

ETag: “200000004b4ee-cda-4ee49099b12b2”

Accept-Ranges: bytes

Content-Length: 3290

Access-Control-Allow-Origin: *

Keep-Alive: timeout=5, max=100

Connection: Keep-Alive

Content-Type: text/plain

Representation: ‘v1’

In our example, a field arbitrarily named “Representation” indicates the representation transmitted by the server. The value “v1” corresponds to a value defined in the description file (see annex 1).

If the value is not present in the description file, the field “Representation” may provide the exact value of the throughput used.

In other words, this field “Representation” is added to indicate the representation to which the content segment belongs in the payload (useful part) of the http response.

Another way of informing the client of the representation selected by the server, corresponding to a second variant, is to insert the information in the media segment, more precisely in a field named “box Event” included in the segment SG.

It should indeed be recalled that, with reference to FIG. 5, in the MPEG DASH standard, a media segment SG includes:
an HD part including HD fields named “box Event”
a useful part named DATA which includes encoded data.

It should be recalled that the field named “box Event” is described in the MPEG DASH standard. It should also be recalled that MPEG DASH (for Dynamic Adaptive Streaming over HTTP-ISO/IEC standard 23009-1:2012(E)) of the organization for standardization ISO/IEC is dedicated to the streaming of multimedia content over the Internet. This standard is incorporated by reference.

In this configuration, with reference to the MPEG DASH standard, the representation indication may be inserted in a field named “box Event” in the HD part. In this way, on reception of the segment SG, the terminal first interprets these “Box Event” fields and may then adapt the parameterization for the decoding of the received segment (F2/500k).

In our example, the HD fields are followed by the encoded data of the current segment. It should be noted that these fields are not found at the beginning of the frame in all cases, but may be found elsewhere in the segment.

After the server sends the stream F2/500k, this is received by the terminal. The remainder of the method is according to the selected variant.

If the first variant has been selected, in one step, the terminal extracts the information representative of the representation. After extraction, the terminal adapts the decoding parameters and then decodes the segment and renders it.

If the second variant has been selected, the terminal then interprets the media segment. In interpreting the latter, the terminal first interprets the “box Event” fields included in the segment and secondly the segment. The terminal is thus aware of the representation and can therefore adapt the parameterization of the decoding as for the first variant.

Therefore it is clear here that at this stage of the method, the terminal is aware of the representation selected by the server and that consequently it can adapt its operation for decoding.

It goes without saying that the embodiment that has been described above has been given purely by way of indication and is in no way restrictive, and that numerous modifications may easily be made thereto by the person skilled in the art without, however, departing from the scope of the invention.

It should be noted that for the embodiment of the inventive method, the terminal includes, in addition to the elements described above with reference to FIG. 2,
a module for transmitting a request for access to at least one segment according to a first selected representation,
a module for receiving said at least one segment according to a second representation, and a piece of information relating to the second representation,
a processing module capable of taking into account the information for decoding the received segment.

It should also be noted that for the embodiment of the inventive method, the server includes, in addition to the elements described above with reference to FIG. 3,
a module for receiving a request for access to at least one segment according to a first selected representation,
a module for transmitting said at least one segment according to a second representation, and a piece of information relating to the second representation.

It should be noted that the term “module” used in this document may correspond either to a software component, or to a hardware component, or to a set of hardware and/or software components, capable of implementing the function or functions described for the module.

TABLE 1
Example of MPD file 4 according to MPEG/DASH
Annex 1

<?xml version=“1.0”?>
<MPD

xmlns:xsi=“HTTP://www.w3.org/2001/XMLSchema-instance”
xmlns=“urn:mpeg:DASH:schema:MPD:2011”
xsi:schemaLocation=“urn:mpeg:DASH:schema:MPD:2011
DASH-MPD.xsd”
type=“dynamic”
minimumUpdatePeriod=“PT2S”
timeShiftBufferDepth=“PT30M”
availabilityStartTime=“2011-12-25T12:30:00”
minBufferTime=“PT4S”
profiles=“urn:mpeg:dash:profile:isoff-live:2011”>
<BaseURL>HTTP://x.com/</BaseURL>
<Period>

<!-- Video -->
<AdaptationSet

mimeType=“video/mp4”
codecs=“avc1.4D401F”
frameRate=“30000/1001”
segmentAlignment=“true”
startWithSAP=“1”>
<BaseURL>video/</BaseURL>
<SegmentTemplate timescale=“90000”
initialization=“$Bandwidth$/init.mp4

[symbol]

media=“$Bandwidth$/$Time$.mp4v”>

<SegmentTimeline>

<S t=“0” d=“180180” r=“432”/>

</SegmentTimeline>

</SegmentTemplate>
<Representation id=“v1” width=“640” height=“480”
bandwidth=“500000”/>
<Representation id=“v2” width=“1280” height=“720”
bandwidth=“2000000”/>

</AdaptationSet>

</Period>

</MPD> [symbol]
indicates data missing or illegible when filed

1. A method for managing the representation of the data segments of a content received by a terminal from a server, the method comprising a step of obtaining a document from which universal addresses are generated, one address being associated with a representation of the segment concerned selected by the terminal from multiple representations described in the document, the segment being capable of being received from the server and decoded by the terminal, characterized in that it includes the following steps at the terminal:
a step of transmitting (ET7) a request for access to at least one segment according to a first selected representation,
a step of receiving (ET8) said at least one segment according to a second representation, and a piece of information relating to the second representation capable of being taken into account for decoding the received segment.

2. The management method as claimed in claim 1, characterized in that the segment received according to the second representation is transmitted in a message including an http header and a part including the segment, and in that the information is included in the http header.

3. The method as claimed in claim 1, characterized in that a segment (SG) includes a first part (HD) including at least one field (N1, N2, . . . ) and a second part (DATA) including at least one coded segment, characterized in that the information is included in a field (N1, N2, . . . ) of said first part.

4. A terminal (1) capable of receiving segments of a content, the terminal having access to a document (4) from which universal addresses are generated, one address being associated with a representation of a segment concerned selected by the terminal from multiple representations described in the document, characterized in that it includes
a module for transmitting a request for access to at least one segment according to a first selected representation,
a module for receiving said at least one segment according to a second representation, and a piece of information relating to the second representation,
a processing module capable of taking into account the information for decoding the received segment.

5. A method of transmission, by a server, of segments of a content according to a given respective representation, characterized in that it includes the following steps:
a step of receiving (ET7) a request for access to at least one segment according to a first selected representation,
a step of transmitting (ET11) said at least one segment according to a second representation, and a piece of information relating to the second representation.

6. A server (8) capable of transmitting segments of a content over a network, characterized in that it includes
a module for receiving a request for access to at least one segment according to a first selected representation,
a module for transmitting said at least one segment according to a second representation, and a piece of information relating to the second representation.

7. A computer program comprising code instructions which, when the program is executed by a processor, performs a method for managing the representation of the data segments of a content received by a terminal from a server, the method comprising a step of obtaining a document from which universal addresses are generated, one address being associated with a representation of the segment concerned selected by the terminal from multiple representations described in the document, the segment being capable of being received from the server and decoded by the terminal, characterized in that it includes the following steps at the terminal:
a step of transmitting (ET7) a request for access to at least one segment according to a first selected representation,
a step of receiving (ET8) said at least one segment according to a second representation, and a piece of information relating to the second representation capable of being taken into account for decoding the received segment.

8. A computer program comprising code instructions which, when the program is executed by a processor, performs a method of transmission, by a server, of segments of a content according to a given respective representation, characterized in that it includes the following steps:
a step of receiving (ET7) a request for access to at least one segment according to a first selected representation,
a step of transmitting (ET11) said at least one segment according to a second representation, and a piece of information relating to the second representation.

9. The method as claimed in claim 2, characterized in that a segment (SG) includes a first part (HD) including at least one field (N1, N2, . . . ) and a second part (DATA) including at least one coded segment, characterized in that the information is included in a field (N1, N2, . . . ) of said first part.

10. The computer program as claimed in claim 7, characterized in that the segment received according to the second representation is transmitted in a message including an http header and a part including the segment, and in that the information is included in the http header.

11. The computer program as claimed in claim 7, characterized in that a segment (SG) includes a first part (HD) including at least one field (N1, N2, . . . ) and a second part (DATA) including at least one coded segment, characterized in that the information is included in a field (N1, N2, . . . ) of said first part.

12. The computer program as claimed in claim 10, characterized in that a segment (SG) includes a first part (HD) including at least one field (N1, N2, . . . ) and a second part (DATA) including at least one coded segment, characterized in that the information is included in a field (N1, N2, . . . ) of said first part.
